(19) United States
(12) Patent Application Publication
(10) Pub. No.: US 2008/0069990 A1
(43) Pub. Date: Mar. 20, 2008

(54) Mold Labeled Injection Moulded Hdpe Container

(75) Inventors: Morten Augestad, Porsgrunn (NO); Arild Follestad, Stathelle (NO)

Correspondence Address: NEEDLE & ROSENBERG, P.C., SUITE 1000, 999 PEACHTREE STREET, ATLANTA, GA, 30309-3915, US

(73) Assignee: BOREALIS TECHNOLOGY OY, Porvoo (FI)

(21) Appl. No.: 11/661,837

(22) PCT Filed: Sep. 7, 2005
(86) PCT No.: PCT/EP05/09603

§ 371 Date: Mar. 5, 2007

(30) Foreign Application Priority Data
Sep. 7, 2004 (GB) 04198522.9

(51) Int. Cl. B29C 45/14

(52) U.S. Cl. 428/35.8; 264/509

(57) ABSTRACT

An injection moulded article comprising an HDPE having a density of greater than 930 kg/m³ and at least one in mould label.

This invention relates to injection moulded articles, in particular to injection moulded polyethylene articles, e.g. bimodal high density polyethylene articles, suitable for packaging solvent based products as well as to processes for the manufacture thereof.

Many aqueous based products such as water-based household paint are typically packaged in polypropylene based containers. Such containers are relatively cheap and simple to make, are light and easy to transport and are strong and potentially recyclable.

Such containers are however, unsuitable for packaging solvent based products and products that cure in the presence of oxygen because polypropylene shows insufficient resistance to solvents and allows oxygen to migrate into the container from the external air. Such containers also fail to sufficiently prevent the egress of solvent, thus allowing the product to deteriorate during storage. Solvent based products such as certain inks, leather tanning products, agricultural pesticides, paints and all kinds of oils etc are therefore conventionally packaged in metal or glass containers.

There remains a need therefore to produce polyolefinic containers for packaging solvent based materials such as paints and for packaging materials which cure in the presence of oxygen which are resistant to solvents and prevent oxygen migration. Such containers must additionally be strong and cheap to manufacture and transport.

The inventors have surprisingly found that a container formed from high density polyethylene (HDPE) and comprising an in mould label can achieve these aims. The HDPE used in the containers of the invention has been found to possess the necessary solvent resistance and by combining this HDPE with an in mould label possessing barrier properties (i.e. a label preventing oxygen migration), a polyolefinic injection moulded article can be formed which may replace the metal or glass containers conventionally employed in the field. Such polyolefinic containers have the additional advantage of being light in comparison to glass or metal containers and are therefore easier to transport and lighter for the end user to carry.

Thus, viewed from one aspect the invention provides an injection moulded article comprising an HDPE having a density of greater than 930 kg/m³, preferably comprising at least two polyethylene components having different molecular weight distributions,

and an in mould label.

Viewed from another aspect the invention provides a process for the preparation of an injection moulded article, said process comprising:

placing an in mould label in an injection mould;

injecting an HDPE having a density of greater than 930 kg/m³ into said mould; and

moulding to form said article.

The HDPE used to form the injection moulded article of the invention may be unimodal. By unimodal is meant that its molecular weight profile (measured by GPC) comprises a single peak. A wide variety of commercially available unimodal HDPE grades are therefore of use in the invention, e.g. MG9641 sold by Borealis AS. The unimodal grades of use may have the properties described in connection with the final polymer composition below.

Preferably however, the HDPE of the invention should comprise at least two components of differing molecular weight distributions, i.e. the HDPE is multimodal, preferably bimodal. The different components may both be ethylene copolymers or ethylene homopolymers, although preferably at least one of the components is a ethylene copolymer. Preferably the HDPE comprises an ethylene homopolymer and an ethylene copolymer component. Each component should form at least 5 wt %, e.g. at least 15 wt % of the HDPE composition.

Where one of the components is an ethylene homopolymer, this is preferably the component with the lower weight average molecular weight (Mw), e.g. where Mw is 5000 to 100000 D, more preferably 20000 to 40000 D.

By polyethylene is meant a polymer the majority by weight of which derives from ethylene monomer units. Minor comonomer contributions, e.g. up to 20% by weight more preferably up to 10% by weight, may derive from other copolymerizable monomers, generally C₃₋₂₀, especially C₃₋₁₀, comonomers, particularly singly or multiply ethylenically unsaturated comonomers, in particular C₃₋₁₀ α-olefins such as propene, but-1-ene, hex-1-ene, oct-1-ene, 4-methyl-pent-1-ene etc.

It may be noted that the term ethylene copolymer is used herein to relate to a polyethylene deriving from ethylene and one or more such copolymerisable comonomers. Moreover, the polyethylene may contain minor, e.g. up to 10% by weight, preferably up to 5% by weight of other polymers, e.g. other polyolefins in particular polypropylenes, as well as additives such as pigments, nucleating agents, antistatic agents, fillers, antioxidants, etc., generally in amounts of up to 10% by weight, preferably up to 5% by weight. Preferably therefore, the polymer component of the injection moulded article of the invention comprises at least 90% wt HDPE, especially 95 wt % HDPE.

By HDPE is meant a polyethylene having a density of greater than 930 kg/m³, e.g. 940 to 980 kg/m³, preferably greater than 945 kg/m³, especially greater than 950 kg/m³ e.g. 950 to 975 kg/m³, especially 950 to 965 kg/m³.

The HDPE should preferably have a crystallinity of 60 to 90%, preferably 70 to 90%.

HDPE with a density and/or crystallinity in the above ranges show enhanced rigidity, especially in the presence of solvents which may swell and weaken the material.

The HDPE according to the invention is preferably a multimodal polymer, erg. a bimodal polymer. Such HDPE has been found to provide highly favourable Environmental Stress Crack Resistance (ESCR), as measured, for example, by the bell test or Full Notch Creep Test, as described herein.

By bimodal (or multimodal), it is meant that the polymer consists of at least two fractions (components), one of which has a relatively lower molecular weight and a relatively higher density and another of which has a relatively higher molecular weight and a relatively lower density. Typically the molecular weight distribution (MWD) of a polymer produced in a single polymerization stage using a single monomer mixture, a single polymerization catalyst and a single set of process conditions (i.e. temperature, pressure etc.) will show a single maximum, the breadth of which will depend on catalyst choice, reactor choice, process conditions, etc, i.e. such a polymer will be monomodal.

A multimodal, e.g. bimodal polyethylene may be produced by blending two or more monomodal polyethylenes having differently centred maxima in their MWDs. Alternatively and preferably the multimodal polyethylene may be produced by polymerization using conditions which create a multimodal (e.g. bimodal) polymer product, e.g. using a catalyst system or mixture with two or more different catalytic sites, each site obtained from its own catalytic site precursor using two or more stage polymerisation process with different process conditions in the different stages or zones (e.g. different temperatures, pressures, polymerisation media, hydrogen partial pressures, etc).

Such a multimodal (e.g. bimodal) HDPE may be produced relatively simply by a multistage ethylene polymerization, e.g. using a series of reactors, with optional comonomer addition in only the reactor(s) used for production of the higher/highest molecular weight component(s) or differing comonomers used in each stage. Examples of bimodal PE production and a complete description of HDPE's suitable for use in the invention is given in EP-A-1187876.

If an ethylene homopolymer component is produced by slurry polymerization involving use of recycled diluent, that diluent may contain small amounts of higher α-olefins as contaminants. Likewise where an earlier polymerization stage has produced an ethylene copolymer component, small amounts of comonomer may be carried over to an ethylene homopolymerization stage. Accordingly, by ethylene homopolymer is meant herein a polymer containing at least 99.9% by weight of ethylene units. Likewise as in a multistage/multireactor polymerization using more than one catalyst system, the homopolymerization catalysts may be at least partially active during the copolymerization reaction, any copolymer component making up less than 5% by weight of the total polymer shall not be considered to be the lowest molecular weight component in an HDPE according to the invention.

The copolymer component(s) of the HDPE used according to the invention will generally contain at least 0.1% by weight, preferably at least 0.5% by weight of non-ethylene monomer units, e.g. 0.5 to 6% of such comonomer units. Preferred ethylene copolymers employ alpha-olefins (e.g. C₃₋₁₂ alpha-olefins) as comonomers. Examples of suitable alpha-olefins include but-1-ene, hex-1-ene and oct-1-ene. But-1-ene is an especially preferred comonomer. The polymerization reactions used to produce the HDPE of use in the articles of the invention may involve conventional ethylene homopolymerization or copolymerization reactions, e.g. gas-phase, slurry phase, liquid phase polymerizations, using conventional reactors, e.g. loop reactors, gas phase reactors, batch reactors etc. (see for example WO97/44371 and WO96/18662). The catalyst systems used may likewise be any conventional systems, e.g. chromium catalysts, Ziegler-Natta and metallocene or metallocene:aluminoxane catalysts, either homogeneous or more preferably heterogeneous catalysts, e.g. catalysts supported on inorganic or organic particulates, in particular on magnesium halides or inorganic oxides such as silica, alumina or silica-alumina.

For the preparation of the higher molecular weight component in particular it is especially desirable to use supported Ziegler-Natta catalysts as the molecular weight can then conveniently be controlled using hydrogen. It is also possible to use supported metallocene catalysts as it is particularly straightforward to select desired molecular weights by appropriate selection of particular metallocenes. The metallocenes used will typically be group IVa to VIa metals (in particular Zr or Hf) complexed by optionally substituted cyclopentadienyl groups, e.g. groups carrying pendant or fused substituents optionally linked together by bridging groups. Suitable metallocenes and aluminoxane cocatalysts are widely described in the literature, e.g. the patent publications of Borealis, Hoechst, Exxon, etc.

Typically and preferably however the HDPE will be prepared using multistage polymerization using a single catalyst system or a plurality of catalyst systems, e.g. two or more metallocenes, one or more metallocenes and one or more Ziegler-Natta catalysts, two or more chromium catalysts, one or more chromium catalysts and one or more Ziegler-Natta catalysts, etc. Especially preferably the same catalyst system is used in the different polymerization stages, e.g. a catalyst system as described in EP-A-688794.

The HDPE used to manufacture the articles of the invention preferably has a lower molecular weight component and a higher molecular weight component.

Lower molecular weight component: The lower molecular weight component may have one or more of the following features:

MFR₂ of 10-1000 g/10 min, preferably 50-800 g/10 min, especially 50 to 600 g/10 min measured according to ISO 1133 at 190° C. and under 2.16 kg load;

weight average molecular weight of 10-90 kD, preferably 20-80 kD, especially 20 to 70 kD;

preferably a homopolymer or a copolymer with density higher than 965 kg/m³, most preferably a homopolymer;

comprises 10-90% by weight, preferably 35-65% by weight of the total polyethylene in the composition.

Higher molecular weight component: The higher molecular weight component may have one or more of the following features:

weight average molecular weight of 60-500 kD, preferably 100 to 400kD;

comprises 10-90% by weight, preferably 35-65% by weight of the total polyethylene in the composition, i.e. low mw:high mw component weight ratio is 10:90 to 90:10, preferably 35:65 to 65:35.

a homopolymer, or preferably a copolymer, especially with another α-olefin, such as copolymers described herein.

Final polymer composition: The final polymer composition (whether unimodal or multimodal) may have one or more of the following features:

MFR₂ of 0.5-100 g/10 min, preferably 1-50 g/10 min, in particular 2-30 g/10 min (e.g. 5-25 or 2 to 10 g/10 min), measured according to ISO 1133 at 190° C. and under 2.16 kg load;

weight average molecular weight of at least 50 kD, e.g. at least 80 kD, preferably 80-200 kD, more preferably 100-180 kD;

molecular weight distribution (ratio of the weight average molecular weight to the number average molecular weight) of 5-60, preferably 8-60, more preferably 14-45;

density of 930-980 kg/m³, preferably 945-975 kg/m³, in particular 950-970 kg/m³;

comonomer content of 0.2-5% by weight, preferably 0.5-3% by weight, more preferably 0.1 to 2.5 wt % as measured by FTIR;

crystalline melting point between 125 and 140° C., as determined by DSC analysis;

crystallinity of 60-85%, more preferably 65-80%, as determined by DSC analysis.

The article of the invention also comprises at least one in mould label. Such a label is a film which possesses low levels of oxygen permeability. The in mould label may be on the inside surface of the article but is preferably on the outside surface thereof. In general, in mould labelling involves a process in which precut labels are placed into a mould cavity before the plastic is introduced. During the moulding process, the label and container melts adhere. Thus, in one preferred embodiment, the article of the invention comprises an injection moulded article of HDPE and an internal in mould label. In a further and most preferred embodiment, the article of the invention comprises an injection moulded article of HDPE and an external in mould label. Where the HDPE is monomodal, it is, however, preferred that the in mould label is internal.

It is preferred if a single in mould label is employed in the invention although it would be possible to use a number of labels (e.g. one internal label and one external label or two labels covering different portions of the injection moulded container).

The in mould label of use in this invention should possess low levels of oxygen permeability. For example at 23° C./75% Relative humidity and an 80 μm film, the oxygen transmission should be less than 100 cc/m²/day, preferably less than 20 cc/m²/day, more preferably less than 10 cc/m²/day.

Polymers of use in the in-mould labels of the invention include polyethylene terephthalate (PET), polyvinyl chloride (PVC), polyethylene naphthalate (PEN), polyamide (PA), polyvinyl alcohol (PVAL), ethylene vinyl alcohol (EVOH), propylene vinyl alcohol (PVOH) polyvinylidene chloride (PVDC), acrylic polymers or mixtures thereof EVOH is a particularly preferred component of in mould labels. These polymers can be combined with other polymers such as polypropylene (PP) and polyethylene (PE) to form labels.

Blends which have been developed and shown to form effective oxygen barriers include EVOH with PP, EVOH with PE, EVOH with PA, PA with PP and PA with PET. PVDC and acrylic polymers are especially suitable as external layers in the in mould label.

Some of the in mould label polymers, e.g. PA, EVOH and PVAL, are more effective when dry and hence when employed in the in mould label of the invention may need to be combined with a water barrier layer. For example, PP is an excellent water vapour barrier and may conveniently be employed along with PA, EVOH to form a film which exhibits both oxygen and water vapour barrier properties. Where PP is employed in the in mould label, it is preferred if this is biaxially orientated.

Moreover, it is possible to metallize the in mould label polymers to improve their oxygen barrier properties. Metallisation is the deposition, in a vacuum chamber, of vaporized molecules of at least one metal (e.g. iron, or particularly aluminium or aluminium alloys) over the surface of a plastic film, thus providing a lustrous metallic appearance. Metallisation is a known process and will be readily carried out by a person skilled in the art.

Other potential films include thin glass-like films formed by coating polymers such as PET, PA or PP with SiOₓ. Such silica coatings can be introduced via physical vapour deposition and are commercialised by Alcan packaging, 4P Ronsberg and Mitsubishi.

Other new barrier technologies may be applicable in the invention claimed, e.g. those commercialised by Ticona (Vectran), Proctor & Gamble (Nodax), Dow (BLOX), Superex Inc. (PET or PA with liquid crystalline polymer) and nanocomposite technology. Laminated labels made from metal foil (e.g. foils of iron, aluminium or alloys) may also be used, as may labels comprising surface modified mica. Such labels provide very effective oxygen and solvent barrier properties.

Preferably however, the in mould label is formed from a multilayer polymeric structure or laminate, e.g. formed from coextrusion by conventional techniques. Such multilayer in mould labels should preferably comprise 2 to 7 layers, e.g. 3 to 5 or 5 to 7 layers. A preferred label comprises external layers compatible with the HDPE which forms the main structure of the article, e.g. the outer layer should comprise PE or PP. The internal layer may thus comprise one of the oxygen barrier materials discussed above, e.g. EVOH. Especially preferred in mould labels are formed from PE-EVOH-PE, PP-EVOH-PP or PP-PVOH-PP optionally comprising one or more adhesive layers. In general, the in mould label should comprise a PVOH or EVOH layer.

The in mould label should preferably be 1 to 200 μm in thickness, e.g. 5 to 120 μm, especially 30 to 100 μm.

The in mould labels of use in this invention can be purchased from Companies such as Vogt, P'Auer, Pachem, Autotype etc.

In mould label technology is well known and conventional techniques may be used to implement its use in the invention, e.g. as described U.S. Pat. No. 4,837,075.

The article of the invention may be manufactured by placing the in mould label in the injection mould, adding the plastic to the mould and carrying out the moulding process. The in mould label may be placed on the male side of the injection mould or the female side of the injection mould depending on whether the in mould label is to be on the inside or outside surface of the article respectively. For the injection moulding conventional moulding equipment may be used, e.g. operating at an injection temperature of 190 to 275° C. and typical pressures, e.g. 500 to 900 bar. Typically containers produced in this fashion will have a volume of 100 mL to 100 L and lids will typically have maximum dimensions of 10 to 600 mm. Container sizes are preferably greater than 100 ml, such as greater than 500 ml, preferably greater than 1 L, especially greater than 10 L.

The in mould label (or labels) should cover at least 50%, e.g. at least 70%, preferably at least 90% of the external surface of the container, e.g. the side or sides of the container and preferably its base. In a most preferred embodiment the label should cover at least 95% e.g. the entire external surface of the injection moulded article, i.e. all external surfaces formed during the injection moulding process.

If the in mould label (or labels) is placed on the inside of the article then it should still cover at least 50%, e.g. at least 70%, preferably at least 90%, more preferably at least 95%, especially all of the internal surface of the container.

The person skilled in the art will appreciate that closures or lids are formed separately and may not comprise the in mould label. It is however, preferable if the closure means or lid also comprises an in mould label, preferably the same label as used on the container. This label may be external or internal on the closure means, preferably external.

The injection moulded article of the invention may have one or more of the following preferred features:

ESCR F₅₀ higher than 10 h, preferably higher than 40 h, especially higher than 200 h measured according to ASTM D1693, Condition B.

FNCT higher than 10 h, preferably at least 18 h according to ISO/DIS 16770.3.

Tensile modulus (E-modulus) of at least 100, preferably at least 700, especially at least 900 MPa (measured according to ISO 527-2);

Impact strength of at least 30 kJ/m² (measured according to ISO 8256-A);

Charpy Impact (23° C., v-notch ISO179:2000] of at least 3 kJ/m², preferably at least 4 kJ/m², more preferably at least 5 kJ/m².

Oxygen transmission of less than 0.2 ml/package 24 h, preferably no more than 0.1 ml/package 24 h, more preferably no more than 0.05 ml/package 24 h, especially no more than 0.025 ml/package 24 h as measured by the AOIR method of Larsen el al. (2000).

In addition, the injection moulded article of the invention exhibits low levels of swell. Many solvents cause swelling accompanied by changes in the physical properties of the article. If the polymer swells too much it will loose mechanical properties e.g. its stiffness (tensile modulus), impact as well as ESCR. The articles of the invention exhibit lower levels of swell than conventional polypropylene articles.

Any suitable material can be packaged using the articles of the invention, e.g. paints in general. However, the materials to be packaged using the article of the invention preferably comprise organic solvents, i.e. are solvent based materials. Solvents which may be employed in goods to be packaged include alcohols, white spirits, aromatics, xylene, butanol, amines, isocyanates and acetates. Goods to be packaged include paints, leather tanning goods, inks, soaps, adhesives, silicones, sealants, industrial and laboratory chemicals. Preferably the injected moulded article is for solvent based paint, more preferably for solvent based alkyd paint.

In this regard, paints often contain binding agents such as alkyd oils. These compounds may also be cured by oxygen migration through the article wall. It has been surprisingly found that the in mould label employed in this invention also reduces or prevents curing of the binding agent containing paints.

Thus, viewed from another aspect the invention provides a paint container, preferably an oxygen curing binder containing paint container (e.g. an alkyd oil containing paint container), comprising an HDPE having a density of greater than 930 kg/m³,

and an in mould label.

It is also believed that containers made from the HDPE composition with in mould label will exhibit prevent emission of the volatile solvents within the container, i.e. will possess low volatile organic compound emissions. This forms a further aspect of the invention.

The invention will now be described further by reference to the following non-limiting Examples:

General

MFR

For PE, MFR₂ is determined at 190° C. using 2.16 kg load according to ISO 1133. For PP measurements are carried out at 230° C.

Density

Density is determined using ISO 1183/D

Environmental Stress Crack Resistance (ESCR)

1) Bell test F50 was measured according to ASTM D1693, Cond.B

2) Full notch Creep test (FNCT) was measured according to ISO/DIS 16770.3 at 23° C. and 12 MPa stress with a notch depth of 1 mm and specimen dimensions 123mm×6 mm×20 mm. The solvent used was 2 vol % Igepal CO-630 in deionized water.

Tensile Properties

Tensile properties were measured on injection moulded samples according to ISO 527-2: 1993. Tensile modulus (E-modulus) was measured at a speed of 1 mm/min

MWD

The weight-average molecular weight Mw and the molecular weight distribution (MWD=Mw/Mn, where Mn equals number average molecular weight and Mw equals to weight average molecular weight) is measured by a method based on ISO 16014-4: 2003. A Waters 150CV plus instrument was used with column 3× HT &E styragel from Waters (divinylbenzene) and trichlorobenzene (TCB) as solvent at 140° C. The column set was calibrated using universal calibration with narrow MWD PS standards. (The Mark Howings constant K: 9.54*10−5 and a:0.725 for PS, and K: 3.92*10−4 and a:0.725 for PE)

The ratio of Mw and Mn is a measure of the broadness of the distribution, since each is influenced by the opposite end of the “population”.

Charpy Impact

This method was applied on injection moulded notched samples according to ISO 179: 2000. The samples are tested at 23° C. and at −20° C.

Comonomer Content

Was determined in a known manner based on FTIR calibrated with 13C NMR.

Swell

Measured according to ISO/FDIS 16101 (method 1)

Permeability

Measured according to ISO DYS 16101

Oxygen Transmission (AIOR Method)

Oxygen transmission rate values were measured by the ambient oxygen ingress rate (AOIR) method as described in the paper by Larsen et al. (2000).

Larsen, H., Kohler, A. and Magnus, E. M. 2000. Ambient Oxygen Ingress Rate method—an alternative method to Ox-Tran for measuring oxygen transmission rate of whole packages. Packag. Technol. Sci. 13(6):233 -241.

### EXAMPLE 1

Reactor Produced Bimodal HDPE Suitable for Use in the Invention

Into a 50 dm³ loop reactor, operated at 80° C. and 65 bar, was introduced 1 kg/hour ethylene, 22 kg/hour propane, 2 g/hour hydrogen and the polymerization catalyst of Example 3 of EP-B-688794 (loaded on 20 micron silica) in a quantity such that PE production rate was 6.8 kg PE/hour. The MFR₂ and density of the product are estimated at 30 g/10 min and 970 kg/m³ respectively. The slurry was continuously removed from the loop reactor and introduced into a second loop reactor having a volume of 500 dm³ operating at 95° C. and 60 bar.. Additional ethylene, propane and hydrogen were added so as to produce a polyethylene at 27 kg/hour having MFR₂ 500 g/10 min and density 974 kg/m³. The polymer (still containing the active catalyst) was separated from the reaction medium and transferred to a gas phase reactor where additional hydrogen, ethylene and 1-butene comonomer were added so as to produce a polyethylene at 70 kg/hour having MFR₂ 4 g/10 min and density 953 kg/m³ (denoted sample 3 in Table 1). The fraction of high MEFR (low MW) material in the total polymer was thus 40%.

Three other samples, denoted 1, 2 and 4 in Table 1, were also produced in this manner.

The properties of samples 1 to 4 are set out in Table 1 below.

TABLE 1

Samples:

| | 1 | 2 | 3 | 4 |
|---|---|---|---|---|
| Mw(kD) | 121 | 170 | 102 | 106 |
| Mn (kD) | 4.2 | 4.1 | 7 | 7.4 |
| MWD | 29 | 41 | 14.5 | 14.3 |
| MFR₂ g/10 min | 2.6 | 1.7 | 3.9 | 3.2 |
| Density (kg/m³) | 963 | 956 | 953 | 953 |
| Ratio LMW/HMW | 40/60 | 60/40 | 40/60 | 40/60 |
| ESCR, F50 (hours) | 46 | 86 | 46 | 43 |
| Tensile modulus (kPa) | 1080 | 930 | 880 | 830 |
| Comonomer content | 0.5 | 1.1 | 1.4 | 1.4 |
| wt % | | | | |

### EXAMPLE 2

The following polymers where used or synthesised:

TABLE 2

| | | HDPE | HDPE | HDPE |
|---|---|---|---|---|
| | PP | unimodal | Bimodal | Bimodal |
| | (BE375MO) | (MG9641) | (I)* | (II)** |
| MFR₂ | 13 | 8 | 3.9 | 7.6 |
| Density | | 964 | 953 | 964 |
| Tensile modulus | 1400 | 1190 | 880 | 1090 |
| [mPa] | | | | |
| Charpy impact | 8.0/4.0 | 6.1/5.0 | | 5.6/3.8 |
| [kj/m²] 23° C./−20° C. | | | | |

*Sample 3 from Example 1.
**Bimodal HDPE II polyethylene composition was produced using the following procedure:

Into a 500 dm³ loop reactor, operated at 95° C. and 56 bar, was introduced 34 kg/hour ethylene, 106 kg/hour propane, 28 g/hour hydrogen and the polymerisation catalyst Lynx 200, a MgCl₂ supported titanium containing catalyst available from Engelhard Corporation Pasadena, U.S.A., in a quantity such that PE production rate was 34 kg PE/hour.

The polymer (containing the active catalyst) was separated from the reaction medium and transferred to a gas phase reactor, operated at 85° C. and 20 bar, where additional hydrogen, ethylene and 1-butene comonomer were added so as to produce a polyethylene at 50 kg/hour.

The reaction conditions applied are listed in the Table below.

| | | Bimodal HDPE II |
|---|---|---|
| loop reactor | | |
| Temperature | ° C. | 95 |
| Pressure | bar | 56 |
| [C₂] | mol % | 1.2 |
| H₂/C₂ ratio | mol/kmol | 197 |
| MFR₂ | g/10 min | 40 |
| Density | kg/m³ | >965 |
| gas phase reactor | | |
| Temperature | ° C. | 85 |
| [C₂] | mol % | 15.2 |
| H₂/C₂ ratio | mol/kmol | 1276 |
| C4/C2 ratio* | mol/kmol | 5 |
| Split | weight % | 60 |

*I-butene comonomer added to the gas phase reactor ata level of 0.02 wt %.

### EXAMPLE 3

In Mould Label

The following in mould label was employed.

80 μm PP-EVOH-PP barrier film (Trade name G.S.V.6) obtainable from Vogt with the properties in Table 3:

TABLE 3

| | Test Method | Unit | Value | |
|---|---|---|---|---|
| Haze | ASTM D1003 | | 6 | |
| Gloss | ASTM D2457 | | 80 | |
| COF | ASTM D1894 | | 0.15-0.30 | |
| Impact Strength | ASTM D1709 | | 80.5 | |
| | | | MD | TD |
| Tensile at yield | ASTM D882 | N/mm² | 21 | 21 |
| Tensile at break | ASTM D882 | N/mm² | 30 | 24 |
| Elong at break | ASTM D882 | (%) | 680 | 642 |
| Tear str | ASTM D1938 | | 11.0 | 10.2 |

| | | | |
|---|---|---|---|
| O₂ Transmission | ASTM D3985 | cc/m²/day | 5 |
| | 23° C./75% RH | | |
| WVTR | ASTM F1249 | g · m²/day | 4 |
| | 38° C./90% RH | | |

(MD = machine direction, TD transverse direction, WVTR is water vapour transmission, COF is coefficient of friction)

Injection Moulded Paint Container

The BE375MO and MG9641 (Borealis AS) and polymer sample 3 of Example 1, were injection moulded using the following procedure to give a container.

Injection moulding took place in a 120 t Nestal Syngergy injection moulding machine employing the conditions below. The formed container was rectangular with a capacity of 0.65 L and wall thickness of 1.2 mm. The lid was produced in the same machine using a separate mould. Containers and lids were made using the polymers set out in Table 2 (the PP from Example 2, unimodal PE MG9641 (available from Borealis AIS) and Sample 3 from Example 1).

Container Injection Moulding Conditions:

Temperature: 250° C.

Holding Pressure: 500 bar

Holding Time: 3 secs

Cooling time: 5 secs

Lid Injection Moulding Conditions:

Temperature: 250° C.

Holding Pressure: 500 bar

Holding Time: 2 secs

Cooling time: 4 secs

An In Mould label was placed manually in the mould for the lid/container prior to plastic injection. The label employed for both container and lid was the butterfly label available from Vogt with barrier properties of O₂TR 5 cc/m2/day described above.

The label covered 95% of the outer surface of the packaging exposed to the container content.

### EXAMPLE 4

Swell Test

Injection moulded plastic samples were tested for their resistance for absorption of different solvents according to ISO/FDIS 16101 (Method A) at 40° C. for 28 days. The tensile modulus of the exposed samples was also recorded according to ISO 527-1/2

TABLE 4

| | PP | | PE Unimodal | | PE Bimodal II | |
|---|---|---|---|---|---|---|
| | Tensile | | Tensile | | Tensile | |
| | Modulus | Swell, wt. % | Modulus | Swell, wt. % | Modulus | Swell, wt. % |
| Solvent | MPa | increase | MPa | increase | MPa | increase |
| White spirit | 200 | 25 | 480 | 7 | 530 | 6 |
| Xylene | 310 | 26 | 570 | 8 | 530 | 7 |
| Paint with air | 280 | 21 | 520 | 7 | 600 | 7 |
| hardening and xylene | | | | | | |
| thinner | | | | | | |

The articles of the invention swell less than the corresponding polypropylene composition.

### EXAMPLE 5

Position of In Mould Label

The permeability of containers comprising in mould labels on the inside or outside surface of the container to xylene was measured as described in ISO DYS 16101 except that the liquid was not changed after prestorage at 40° C., for containers. In mould labels as described in Example 3 were either placed on the male or female side of the injection mould to yield, after moulding, containers having an in mould label on the inside and outside surface respectively. The labels each covered at least 95% of their respective surface.

| | | EVOH in | EVOH in |
|---|---|---|---|
| | Standard i.e. | mould label on | mould label on |
| Xylene | no in mould | outside of | inside of |
| MG9641 | label | container | container |
| Storage 40° C. start | 465.6 | 472.7 | 470.1 |
| [g] | | | |
| Storage 40° C. end [g] | 406.0 | 460.3 | 463.2 |
| Delta weight 40° C. | 59.6 | 12.4 | 6.9 |
| 21 days [g] | | | |
| Storage 23° C. start | 406.0 | 460.8 | 463.2 |
| [g] | | | |
| Storage 23° C. end [g] | 373.2 | 450.7 | 459.3 |
| Delta weight 23° C. | 32.8 | 9.7 | 3.9 |
| 28 days [g] | | | |
| Total weight loss 49 | 92.3 | 22.1 | 10.8 |
| days [g] | | | |
| Total weight loss 49 | 19.8 | 4.7 | 2.3 |
| days [wt %] | | | |

### EXAMPLE 6

ESCR, Full notch Creep test (FNCT) was measured according to ISO/DIS 16770.3 with the solvents as indicated in the table. It was measured at 23° C. and 12 MPa stress with a notch depth of 1 mm and specimen dimensions 123mm×6 mm×20 mm.

| Solvent | Unimodal | Bimodal I |
|---|---|---|
| Igepal CO-630 | 6 | 20 |
| (2 vol % in deionized water) | | |
| White spirit | 11 | 16 |
| Xylene | 8 | 9 |
| Solvent based paint | 21 | 108 |

### EXAMPLE 7

Oxygen Transmission

Oxygen transmission rate values were measured by the ambient oxygen ingress rate (AOIR) method as described in the paper by Larsen et al. (2000). AOIR is a method to measure oxygen transmission rate for the whole packaging. The packages were mounted to a combined flushing and sampling port prior to flushing with nitrogen. The first (initial) O₂-concentration in the packages was measured after 1 day of storage at 23° C. and 50% RH. The second (final) O₂-concentration in the packages was measured after 4 days of storage at the same storage conditions. The O₂-concentration was measured by the use of a specially designed syringe for gas sampling, and the gas sample was injected into a Mocon/Toray oxygen analyser LC-700F (Modem Controls Inc, Minnesota, USA) with a zirconium oxide cell. Additionally, the volume of the packages was registered. The oxygen transmission rate of the packages, given as ml O₂/package/day, was finally calculated according to the equations given by Larsen el al. (2000).

Polyethylene from Sample 3 of Example 1 was used to prepare containers with no label and containers with an EVOH in mould label covering 95% of the container area. The AOIR for the two sets of containers was measured and the results are shown in the table below.

| | PE - no label | PE - EVOH IML |
|---|---|---|
| Oxygen Transmission rate | 0.25 ± 0.00 | 0.02 ± 0.00 |
| [ml/pkg 24 hr] | | |

A reduction of oxygen transmission of 90% was observed by the inclusion of an in mould label.

Larsen, H., Kohler, A. and Magnus, E. M. 2000. Ambient Oxygen Ingress Rate method—an alternative method to Ox-Tran for measuring oxygen transmission rate of whole packages. Packag. Technol. Sci. 13(6):233-241.

1. An injection moulded article comprising an HDPE having a density of greater than 930 kg/m³ and at least one in mould label.

2. The article as claimed in claim 1 wherein said in mould label is an internal in mould label.

3. The article as claimed in claim 1 wherein said in mould label is an external in mould label.

4. The article as claimed in claim 1 wherein the HDPE comprises at least two polyethylene components having different molecular weight distributions.

5. The article as claimed in claim 4 wherein at least one of said polyethylene components is a polyethylene copolymer.

6. The article as claimed in claim 5 wherein another component is a polyethylene homopolymer.

7. The article as claimed in claim 1 wherein the HDPE has a density of at least 950 kg/m³.

8. The article as claimed in claim 1 having an oxygen transmission of less than 0.2 ml/24 h.

9. The article as claimed in claim 1 wherein said in mould label has an oxygen transmission of less than 100 cc/m²/day at 23° C. and 75% relative humidity.

10. The article as claimed in claim 1 wherein said in mould label comprises at least one polymeric material selected from the group of polyethylene terephthalate, polyvinyl chloride, polyethylene naphthalate, polyamide, polyvinyl alcohol, ethylene vinyl alcohol, propylene vinyl alcohol, polyvinylidene chloride and acrylic polymers.

11. The article as claimed in claim 1 wherein said in mould label is a multi layered laminate.

12. The article as claimed in claim 1 wherein said in mould label is metallised.

13. The article as claimed in claim 1 wherein the in mould label comprises EVOH.

14. The article as claimed in claim 1 comprising at least one in mould label covering a total of at least 50% of the surface of said article.

15. The article as claimed in claim 1 being a container containing a solvent based product selected from the group of paints, leather tanning goods, inks, soaps, adhesives, silicones, sealants, industrial and laboratory chemicals or a container containing a product which cures in air.

16. The article as claimed in claim 15 wherein said product comprises at least one solvent selected from the group of alcohols, white spirits, aromatics, xylene, butanol, amines, isocyanates and acetates.

17. The article as claimed in claim 1 being a paint container.

18. The article of claim 17 wherein said container contains solvent based paint.

19. A process for the preparation of an injection moulded article, said process comprising:
placing an in mould label in an injection mould;
injecting an HDPE having a density of greater than 930 kg/m³ into said mould; and
moulding to form said article.

20. The process as claimed in claim 19 wherein said in mould label is placed on a female side of said mould.

21. The process as claimed in claim 20 wherein said in mould label is placed on a male side of said mould.
